(19) United States
(12) Patent Application Publication
(10) Pub. No.: US 2016/0349761 A1
(43) Pub. Date: Dec. 1, 2016

(54) Pressure Independent Control Valve

(71) Applicant: Bray International, Inc., Houston, TX (US)

(72) Inventors: Craig Brown, Houston, TX (US); Erich Schroeder, Houston, TX (US); Steve Drollinger, Houston, TX (US); Kevin Poniatowski, Lisle, IL (US)

(21) Appl. No.: 15/169,536

(22) Filed: May 31, 2016

Related U.S. Application Data
(60) Provisional application No. 62/168,499, filed on May 29, 2015.

(51) Int. Cl. G05D 7/01; F16K 37/00; F16K 3/24

(52) U.S. Cl. CPC G05D 7/0106; F16K 3/24; F16K 37/0016

(57) ABSTRACT

The disclosure relates to a pressure independent controlled valve having an axis intersecting a flow path of a pipe system and having a valve housing having a top end and a bottom end, the valve having an valve stem positioned along the axis, wherein the valve stem traverses through the housing; a fixed outer ring within the housing and surrounding the valve stem; a first inner ring within the fixed outer ring, wherein the first inner ring defines a first opening; a second inner ring within the first inner ring, wherein the second inner ring defines a second opening; a key configured to maneuver the first inner ring; and an actuator configured to maneuver the second inner ring.

### STATEMENTS REGARDING FEDERALLY SPONSORED RESEARCH OR DEVELOPMENT

Not Applicable.

### NAMES OF THE PARTIES TO A JOINT RESEARCH AGREEMENT

Not Applicable.

### REFERENCE TO A “SEQUENCE LISTING”, A TABLE, OR A COMPUTER PROGRAM

Not Applicable.

### BACKGROUND

Technical field

The disclosure relates to valve systems used in heating, ventilation, and air-cooling (HVAC) pipe systems, including in regard to pressure independent control valves used to control, adjust and regulate a desired fluid flow rate.

Other known systems relating to pressure independent control valves are described in U.S. Pat. No. 8,469,052, U.S. Pat. No. 7,967,023, WO 2009006893, WO 2014044282, and US 2014/0191148 the teachings of all of which are hereby incorporated by reference.

### BRIEF SUMMARY OF THE EMBODIMENTS

The disclosure relates to a pressure independent controlled valve having an axis intersecting a flow path of a pipe system and having a valve housing having a top end and a bottom end, the valve having an valve stem positioned along the axis, wherein the valve stem traverses through the housing; a fixed outer ring within the housing and surrounding the valve stem; a first inner ring within the fixed outer ring, wherein the first inner ring defines a first opening; a second inner ring within the first inner ring, wherein the second inner ring defines a second opening; a key configured to maneuver the first inner ring; and an actuator configured to maneuver the second inner ring.

As used herein, the terms “axial,” “linear,” or “linearly” in regards to movement or motion shall refer to movement along, up or down, or parallel to an axis (e.g. major axis), as defined by the valve stem of the valve system.

As used herein, the terms “rotational,” “rotating,” “angular,” “horizontal,” or “horizontally” in regards to movement or motion shall refer to movement around or about an axis, as defined by the valve stem of the valve system.

### BRIEF DESCRIPTION OF THE SEVERAL VIEWS OF THE DRAWINGS

The embodiments may be better understood, and numerous objects, features, and advantages made apparent to those skilled in the art by referencing the accompanying drawings. These drawings are used to illustrate only typical embodiments of this invention, and are not to be considered limiting of its scope, for the invention may admit to other equally effective embodiments. The figures are not necessarily to scale and certain features and certain views of the figures may be shown exaggerated in scale or in schematic in the interest of clarity and conciseness.

FIG. 1 depicts an assembly perspective view of one exemplary embodiment of a pressure independent control (or PIC) valve system.

FIG. 2 depicts a cross section view of an exemplary embodiment of a pressure independent control valve system and an internal diaphragm.

FIG. 3 depicts a combination perspective and bottom view of an alternative exemplary embodiment of a PIC valve system.

FIG. 4 depicts a combination perspective and bottom view of an alternative exemplary embodiment of a PIC valve system having a characterized second inner cartridge.

FIG. 5 depicts a partial cross section view of an alternative exemplary embodiment the PIC valve system in a fully open position.

FIG. 6 depicts a partial cross section view of the PIC valve system in FIG. 5 in a partially open position.

### DESCRIPTION OF EMBODIMENT(S)

The description that follows includes exemplary apparatus, methods, techniques, and instruction sequences that embody techniques of the inventive subject matter. However, it is understood that the described embodiments may be practiced without these specific details.

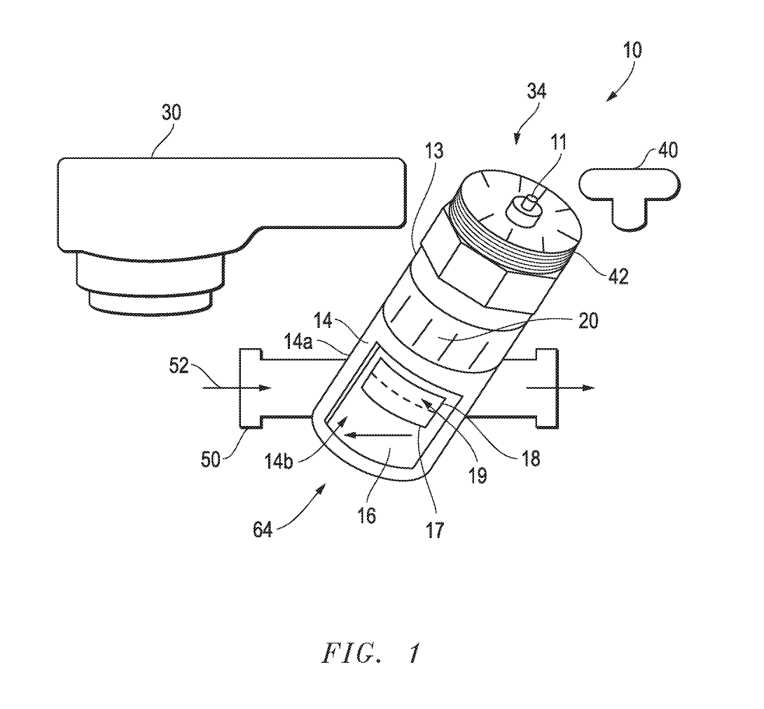

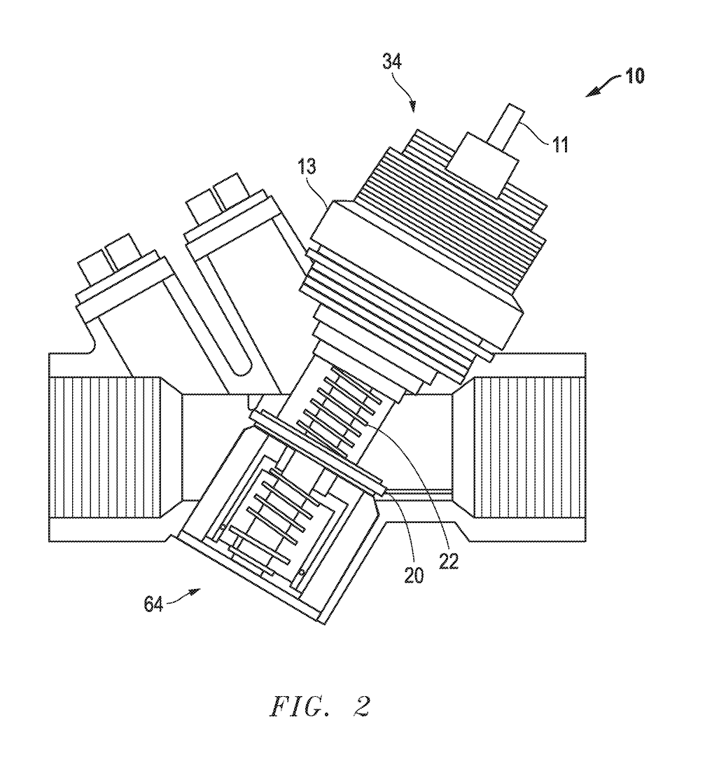

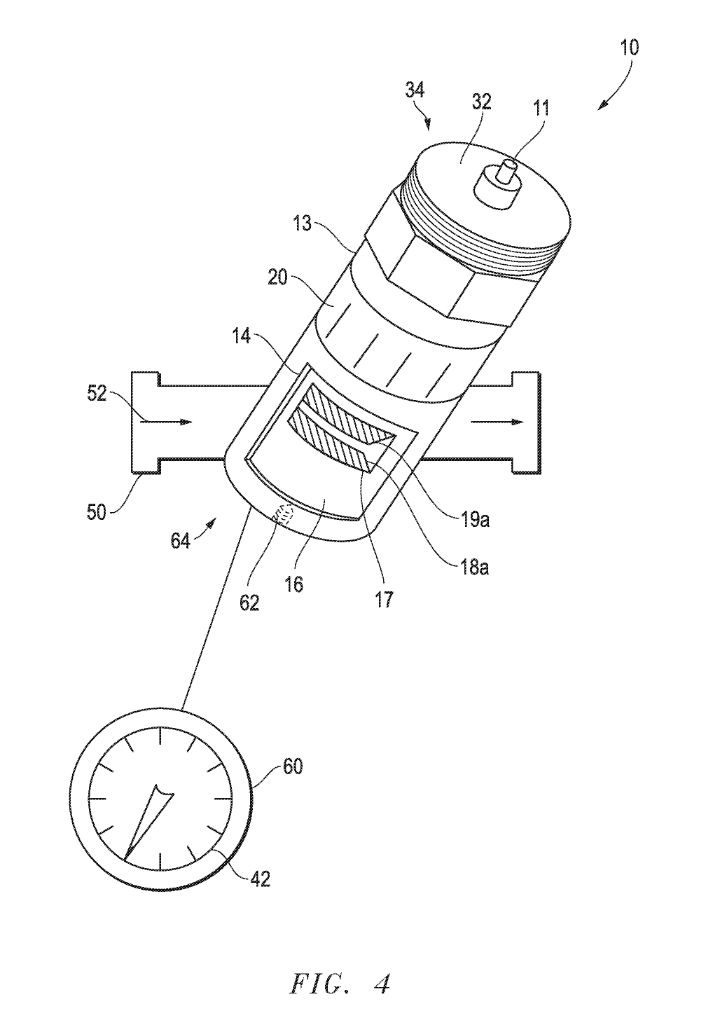

FIG. 1 depicts one embodiment of an improved pressure independent control (or PIC) valve or valve system 10 in which a flow path 52 runs there through as part of a pipe system 50, wherein the adjustment of the maximum flow rate may be set through the top end 34 of the valve system 10. The valve system 10 may have a housing 13 inserted into the pipe system 50. The housing 13 may have a top end portion 34 and a bottom end portion 64. Within the housing 13, the valve system 10 may include a fixed outer ring 14, which houses or surrounds a first inner ring 16, and wherein the first inner ring 16 houses or surrounds a second inner ring or internal cartridge 18. The fixed outer ring 14 may have sidewalls 14a (by way of example only, stirrup-like) defining an outer opening(s) 14b. The first inner ring 16 may define a first opening 17 and the second inner ring 18 may define a second opening 19. As shown in FIG. 4, in alternate exemplary embodiments, the second inner ring 18 may be a characterized inner ring 18a which defines a characterized opening 19a. By way of example only, the characterized opening 19a may be defined as an angular shaped opening, but may also be defined as having other shapes or configurations. A valve stem, axle or spindle 11 may traverse through the valve housing 10 and may be configured to transmit force to the second inner ring 18. The valve stem 11 may lie along an axis of the valve housing 13, and the axis of said valve housing 13 may intersect the flow path 52. A key or adjustment key 40 may be mounted on the top end 34 of the valve stem 11 to transmit motion from the key 40 to the first inner ring 16. The top end 34 may have an indicator face or dial 42 which may display the maximum flow rates at which the valve 10 may be set to. The valve system 10 may include an actuator 30, wherein the actuator 30 is configured to manipulate or control the second inner ring 18 and to have an input signal set as determined by the operator of the valve system 10 or by the actuator 30 itself. By way of example only, the actuator 30 may be an electric actuator and if the input signal is 10 volts (or 10V), the actuator 30 may manipulate the second internal cartridge 18 to a fully open position. As a further example, if the input signal is 0 volts (or 0V), the actuator 30 may manipulate the second internal cartridge 18 into a fully closed position. The actuator 30 may further be able to fine-tune or modulate the second internal cartridge 18 between the fully open and the fully closed position. By way of example only, if the input signal is 5 volts (or 5V), the actuator 30 may manipulate the second internal cartridge 18 to a partially open position. In addition, the adjustment key 40 may be removed prior to attaching the actuator 30 to the top end 34 of the valve housing 13. As shown in the cross section view of FIG. 2, the valve housing 13 may further include a diaphragm 20 mounted to a spring 22 for regulation of pressure in the valve system 10.

In a first exemplary embodiment, the adjustment key 40 may linearly move the first inner ring 16 and the first opening 17 within the fixed outer ring 14. The adjustment key 40 may thus set the maximum allowable flow rate through the valve system 10 in this manner. The internal diaphragm 20 within the housing 13 may also move or fluctuate linearly in reaction to the pressure entering the valve system 10, so as to regulate the pressure in the valve system 10 and to maintain a desired flow rate. The actuator 30 may then be also mounted to top 34 of the valve system 10 and move the second internal cartridge or inner ring 18 linearly to modulate the flow based on the input signal from the actuator 30.

In a second exemplary embodiment, the adjustment key 40 at the top end 34 of the valve housing 13 may rotate the first internal or inner ring 16 horizontally within the fixed outer ring 14 in order to set a maximum flow rate for the valve system 10. The spring 22 mounted internal diaphragm 20 moves linearly in reaction to pressure entering the valve system 10. The actuator 30 may mount to the top 34 of the valve system 10 and move the second internal cartridge 18 horizontally to modulate the flow rate based on the input signal. The second internal cartridge 18 in this alternate exemplary embodiment may be a characterized cartridge 18a having a characterized opening 19a (the characterized cartridge 18a and characterized opening 19a may be seen in the alternate exemplary embodiment as depicted in FIG. 4).

In a third exemplary embodiment, the adjustment key 40 at the top 34 may move the first inner ring 16 linearly within the fixed outer ring 14 to set the maximum flow rate. The spring 22 mounted internal diaphragm 20 moves linearly in reaction to pressure entering the valve system 10. The actuator 30 may mount to the top 34 of the valve system 10 and move the second internal cartridge 18 horizontally to modulate the flow rate based on the input signal. The second internal cartridge 18 in this alternate exemplary embodiment may be a characterized cartridge 18a having a characterized opening 19a (as depicted in FIG. 4).

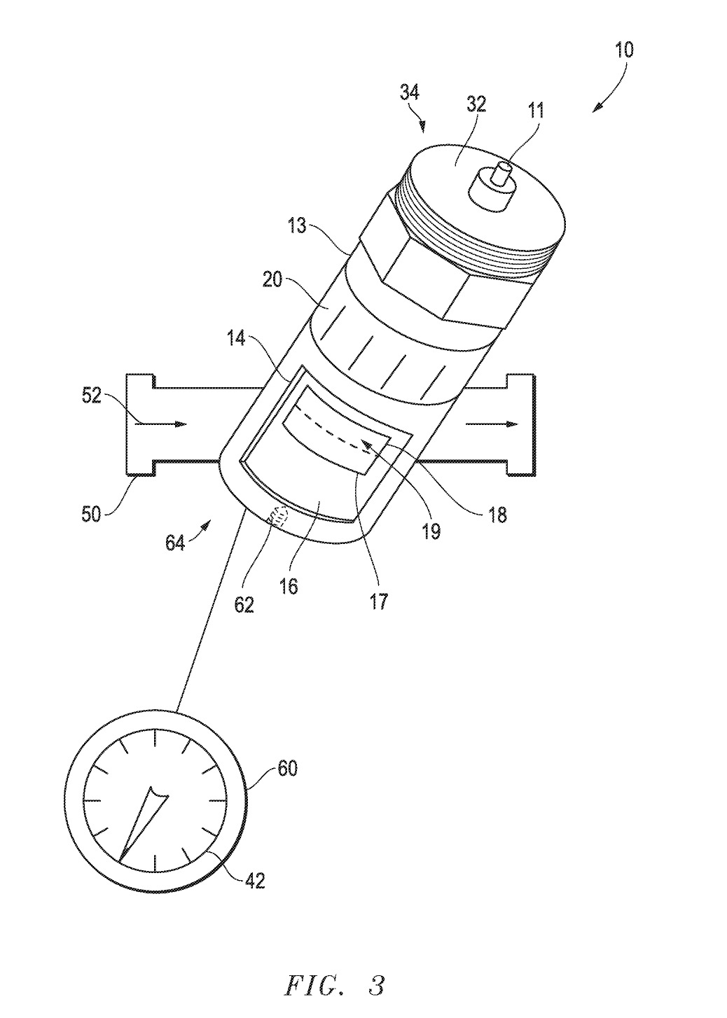

FIGS. 3 and 4 depict combination assembly perspective views of alternative exemplary embodiments of pressure independent control (or PIC) valve systems 10 in which a flow path 52 runs there through as part of a pipe system 50, wherein the adjustment of the flow rate may be set through both the top end 34 and the bottom end 64 of the valve system 10. The valve system 10 may have a housing 13 inserted into the pipe system 50. The housing 13 may have a top end portion 34 and a bottom end portion 64. Within the housing 13, the valve system 10 may include a fixed outer ring 14, which houses or surrounds a first inner ring 16, and wherein the first inner ring 16 houses or surrounds a second inner ring or internal cartridge 18. As shown in FIG. 3, the first inner ring 16 may define a first opening 17 and the second inner ring 18 may define a second opening 19. As shown in FIG. 4, the second inner ring 18 may be a characterized inner ring 18a which defines a characterized opening 19a. By way of example only, the characterized opening 19a may be defined as an angular shaped opening, but may also be defined as having other shapes or configurations (e.g. curve shape, etc.). As in the embodiments shown in FIG. 1, a valve stem, axle or spindle 11 may traverse through the valve housing 10 and may be configured to transmit force to the second inner ring 18. The valve system 10 in FIG. 3 has an actuator mount 32 at one end, or the top end 34, of the valve system 10 and a bottom adjustable flow limiter 60 at the opposite end, or the bottom end 64, of the valve system 10. The actuator mount 32 may allow an actuator 30 (as depicted in FIG. 1) to engage or connect with the valve stem 11 or otherwise manipulate the second inner ring 18. The actuator 30 may be an electric actuator and may perform as substantially described above in the description for FIG. 1. Further, the bottom adjustable flow limiter 60 may display a dial or indicator face 42 and may mount onto the valve housing 13 via a threaded flow limiter adjustment or other engagement means 62. The threaded flow limiter adjustment or engagement means 62 may be connected to or transmit force or motion to the first internal ring 16. An adjustable key 40 (as illustrated in FIG. 1) may also be connected at the bottom of the valve housing 13 via the threaded flow limiter adjustment 62 for modifying, controlling or manipulating the first inner ring 16.

By way of example only, in a fourth alternate exemplary embodiment, the adjustment key 40 at the bottom end 64 may move the first inner ring 16 linearly within the fixed outer ring 14 to set a maximum flow rate through the valve system 10. The spring 22 mounted diaphragm 20 may move linearly within the valve system 10 in reaction and to regulate the system pressure. The actuator 30 may then mount to the top 34 of the valve housing 13, on the actuator mount 32, to move a second internal most cartridge or ring 18 linearly to modulate the flow rate based on the input signal from the actuator 30.

In a fifth alternate exemplary embodiment, the adjustment key 40 at the bottom 64 of the valve housing 13 may rotate the first internal ring 16 horizontally within the fixed outer ring 14 to set a maximum flow rate for the valve system 10. The internal diaphragm 20 may move linearly in reaction to the system pressure. The actuator 30 may mount to the top 34 of the valve housing 13 and move a second characterized internal most cartridge 18a horizontally to modulate the flow rate based on the input signal of the actuator 30.

In a sixth alternate exemplary embodiment, the adjustment key 40 at the bottom 64 of the valve housing 13 may move the first inner ring 16 linearly within the fixed outer ring 14 to set a maximum flow rate. The spring 22 mounted diaphragm 20 may move linearly in reaction to the valve system 10 pressure. The actuator 30 may mount to the top 34 of the valve housing 13 and move a second characterized internal most cartridge 18a horizontally to modulate the flow rate based on the input signal to the actuator 30.

In a seventh alternate exemplary embodiment, the adjustment key 40 at the bottom 64 of the valve housing 13 may move the first inner ring 16 horizontally within the fixed outer ring 14 to set a maximum flow rate. The spring 22 mounted diaphragm 20 may move linearly in reaction to the valve system 10 pressure. The actuator 30 may mount to the top 34 of the valve housing 13 and move a second internal most cartridge 18 linearly to modulate the flow rate based on the input signal to the actuator 30.

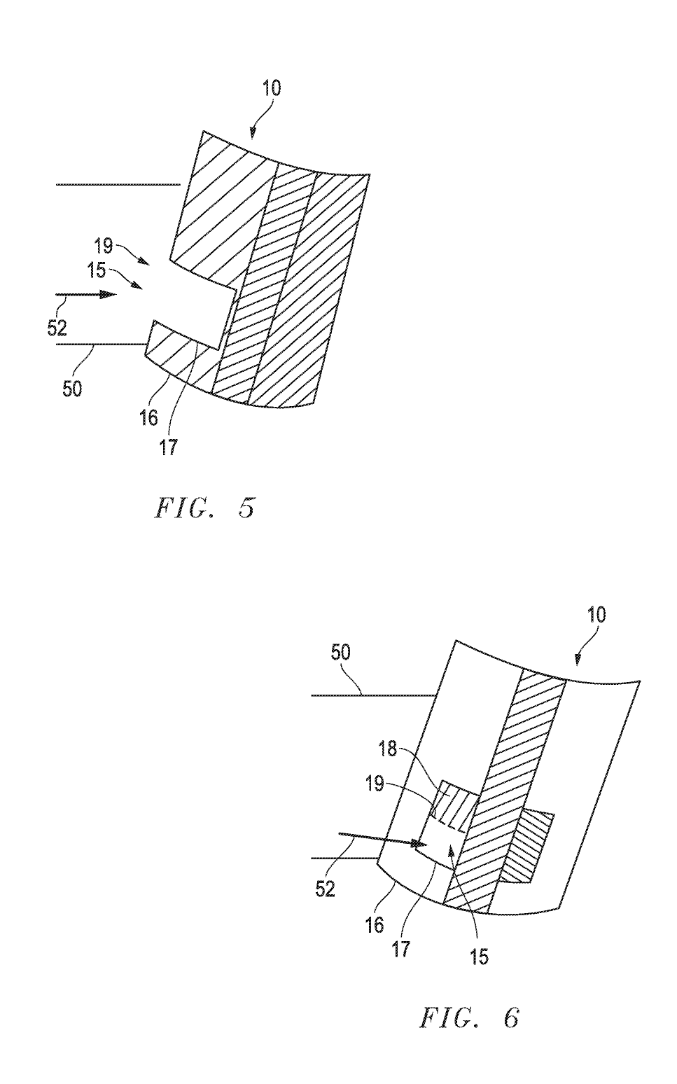

FIG. 5 depicts a partial cross section view of an alternative exemplary embodiment the PIC valve system 10 in a fully open position in pipe system 50. FIG. 6 depicts a partial cross section view of the PIC valve system 10 of FIG. 5 in a partially open position in pipe system 50. The exemplary embodiment of the valve system 10 as shown in FIGS. 5-6 have a first inner ring 16 which is horizontally manipulated by the adjustment key 40, and a second inner ring 18 which is linearly manipulated by the actuator 30. The adjustment key 40 may be located at either the top 34 or the bottom 64 in the exemplary embodiment of FIGS. 5-6. In FIG. 5, the first inner ring opening 17 is rotatably set into the position for the maximum flow rate through the flow path 52 of the pipe system 50. The second inner ring 18 in FIG. 5 is linearly set into the fully open position and thus is not shown as the second inner ring 18 is fully retracted behind the first inner ring 16 so as to not obstruct the flow path 52, and to allow the flow path 52 to move through the second inner opening 19 (or a window or space 15 as variably defined by the aligned openings 17, 19). In FIG. 6, the first inner ring 16 and the first inner ring opening 17 are rotatably set to a position and corresponding maximum flow rate which is a percentage, fraction or some portion of the maximum flow rate of the fully open valve 10. As a result, in FIG. 6, a portion of the first inner ring opening 17 is obscured and partially blocks the flow path 52. Furthermore, the second inner ring 18 is linearly set into a partially open position as well in FIG. 6, such that the flow path 52 moves through a window or space 15 as defined by the partial alignment of the second inner ring opening 19 and the first inner ring opening 17, and is accordingly modulated from the maximum flow rate as set by the first inner ring 16. By way of example only, the first inner ring 16 in FIG. 6 may be set to half of the maximum flow rate, and the second inner ring 18 in FIG. 6 may be set to be half open.

While the embodiments are described with reference to various implementations and exploitations, it will be understood that these embodiments are illustrative and that the scope of the inventive subject matter is not limited to them. Many variations, modifications, additions and improvements are possible. For example, the techniques used herein may be applied to any valve system or assembly used for piping systems. Further, while the actuator 30 and the adjustment key 40 are depicted as being mounted to the top 34 of the valve system 10 in one exemplary embodiment and in an alternate exemplary embodiment wherein the actuator 30 is at the top end 34 and the adjustment key 40 is on the bottom end 64, it is to be appreciated that one or both of the actuator 30 and adjustment key 40 may instead by mounted to the bottom end 64 and in an alternate embodiment, the adjustment key 40 may be mounted to the top end 34 of the valve system 10 and the actuator 30 to the bottom end 64 to perform the adjustment or control of the rings 16, 18 respectively. Moreover, the bottom adjustable flow limiter 60 may be adapted to allow flow through the bottom instead of the sidewalls as adjusted by the threaded flow limiter adjustment 62.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A pressure independent controlled valve apparatus having an axis intersecting a flow path of a pipe system and having a valve housing having a top end and a bottom end, comprising:
a valve stem positioned along the axis, wherein the valve stem traverses through the housing;
a fixed outer ring within the housing and surrounding the valve stem;
a first inner ring within the fixed outer ring, wherein the first inner ring defines a first opening;
a second inner ring within the first inner ring, wherein the second inner ring defines a second opening;
a key configured to maneuver the first inner ring; and
an actuator configured to maneuver the second inner ring.

2. The valve apparatus according to claim 1, further comprising a spring within the housing; and a diaphragm mounted to the spring.

3. The valve apparatus according to claim 1, wherein the first inner ring is configured for linear movement.

4. The valve apparatus according to claim 1, wherein the first inner ring is configured for horizontal movement.

5. The valve apparatus according to claim 1, wherein the second inner ring is configured for linear movement.

6. The valve apparatus according to claim 1, wherein the second inner ring is configured for horizontal movement.

7. The valve apparatus according to claim 1, wherein the key is connected to the valve at the top end of the housing.

8. The valve apparatus according to claim 1, wherein the key is connected to the valve at the bottom end of the housing.

9. The valve apparatus according to claim 8, further comprising a bottom adjustable flow limiter mounted to the bottom end of the housing, connected to the first inner ring, and connectable to the key.

10. The valve apparatus according to claim 1, wherein the second inner ring is a characterized inner ring and wherein the second opening is a characterized opening.

11. A pressure independent controlled valve apparatus having an axis intersecting a flow path of a pipe system and having a valve housing having a top end and a bottom end, comprising:
a valve stem positioned along the axis, wherein the valve stem traverses through the housing;
a spring within the housing;
a diaphragm mounted to the spring
a fixed outer ring within the housing and surrounding the valve stem;
a first inner ring within the fixed outer ring, wherein the first inner ring defines a first opening;
a second inner ring within the first inner ring, wherein the second inner ring defines a second opening;
a key configured to maneuver the first inner ring;
an actuator configured to maneuver the second inner ring;
wherein the first inner ring is configured for linear movement; and
wherein the second inner ring is configured for linear movement.

12. The valve apparatus according to claim 11, wherein the key is connected to the valve at the top end of the housing.

13. The valve apparatus according to claim 11, wherein the key is connected to the valve at the bottom end of the housing.

14. The valve apparatus according to claim 13, further comprising a bottom adjustable flow limiter mounted to the bottom end of the housing, connected to the first inner ring, and connectable to the key.

15. The valve apparatus according to claim 11, wherein the second inner ring is a characterized inner ring and wherein the second opening is a characterized opening.

16. A method of controlling a flow rate using a pressure independent controlled valve, wherein the valve has a housing along an axis which intersects a flow path, comprising the steps of:
moving a first inner ring within the housing, wherein the first inner ring defines a first opening;
moving a second inner ring within the first inner ring, wherein the second inner ring defines a second opening; and
adjusting a diaphragm linearly within the housing in response to pressure change within the valve.

17. The method of claim 16, wherein the step of moving the first inner ring comprises moving the first inner ring linearly, and the step of moving the second inner ring comprises moving the second inner ring linearly.

18. The method of claim 16, wherein the step of moving the first inner ring comprises moving the first inner ring horizontally, and the step of moving the second inner ring comprises moving the second inner ring horizontally.

19. The method of claim 16, wherein the step of moving the first inner ring comprises moving the first inner ring linearly, and the step of moving the second inner ring comprises moving the second inner ring horizontally.

20. The method of claim 16, wherein the step of moving the first inner ring comprises moving the first inner ring horizontally, and the step of moving the second inner ring comprises moving the second inner ring linearly.
